(19) United States
(12) Patent Application Publication
(10) Pub. No.: US 2026/0344574 A1
(43) Pub. Date: Nov. 5, 2026

(54) THRESHING SYSTEM OF A COMBINE HARVESTER

(71) Applicant: AGCO do Brasil Soluções Agrícolas Ltda., Jundiaí-São Paulo (BR)

(72) Inventor: Marcelo Carpenedo, Jundiaí-São Paulo (BR)

(21) Appl. No.: 19/656,166

(22) Filed: Apr. 23, 2026

(30) Foreign Application Priority Data
Apr. 28, 2025 (GB) 2506417.1

(51) Int. Cl. A01F 12/18; A01F 7/04; A01F 12/22

(52) U.S. Cl. CPC A01F 12/185; A01F 7/04; A01F 12/22

(57) ABSTRACT

A threshing drum for a combine harvester has a central shaft and a set of drum sections disposed side-by-side along the central shaft. The drum sections are movable axially along the central shaft, and this is used to slide the threshing drum out of the combine harvester. Each drum section comprises at least two portions which are connected together to fix the drum section around the central shaft. The at least two portions are disconnectable such that they are removable from the shaft in a radial direction of the shaft. Thus, the threshing drum can be removed from the combine harvester in axial sections, and splitting those axial sections to separate them from the central shaft.

### CROSS-REFERENCE TO RELATED APPLICATION

This application claims the benefit of the filing date of United Kingdom Patent Application 2506417.1, filed Apr. 28, 2025, the entire disclosure of which is incorporated herein by reference.

### FIELD

Embodiments of the present disclosure relate generally to combine harvesters, and in particular to the threshing system of a combine harvester.

### BACKGROUND

A combine harvester typically includes a crop cutting head (header) and a threshing system for detaching grains of cereal from the ears of cereal. A delivery system, known as the feederhouse, delivers the cut crop to the threshing system. The threshing system is for detaching grains of cereal from the ears of cereal. A separating apparatus is downstream of the threshing system, and a grain cleaning apparatus receives grain from the separating apparatus.

The header is typically in the form of a wide array of cutters and a delivery auger (or belt) to feed the cut material to the central feederhouse. The feederhouse is typically in the form of a conveyor chain with cross bars that transport the crop material.

There are various designs for the threshing system and for the separating apparatus (e.g. axial or transverse) as well as for the grain cleaning apparatus. However, in all designs, there is a flow of material from the threshing system to the separating apparatus, and between the separating apparatus and the grain cleaning unit, in particular from a stratification pan to the grain cleaning unit.

The threshing system typically comprises threshing rotors that rotate with respect to concave gratings (known simply as “concaves”). As mentioned above, the threshing rotors may be arranged transversally or longitudinally with respect to the direction of travel of the combine harvester.

The most traditional threshing systems is the transverse threshing system, commonly called “conventional” threshing, where the rotor combined with its static concave is placed transversally to the machine, receiving all the material coming from the feeding system in a perpendicular flow. This allows the material to be processed without the need for a change in direction. The separating system may for example comprise a straw walker system, resulting in a “conventional straw walker” combine . . . A so-called “hybrid” combine employs conventional threshing, but axial separation (i.e. using a rotor that rotates about an axis in the longitudinal direction of the combine).

Conventional or hybrid combines have versatility and low cost compared to axial combines (which combine axial threshing and axial separation). Axial combines are usually associated with high performance solutions. Conventional and hybrid combines are lower cost compared to axial combines due to the smaller number of parts and size of components.

One issue with conventional threshing is the difficulty to setup the machine when changes are necessary on the threshing drum, because this part is not easily removed. To to this, it is typically necessary to remove the entire threshing cylinder through the lateral side of the machine, expending many hours of labor, with at least two people involved. Sometimes, there is also the need to remove the front wheel to enable this procedure, increasing significantly the time to proceed.

There is therefore a need for a conventional (transverse) threshing solution that simplifies the setup process.

### BRIEF SUMMARY

The concepts underlying this disclosure are defined by the claims. According to examples in accordance with this disclosure, there is provided a threshing drum for a combine harvester, comprising a central shaft and a set of drum sections disposed side-by-side along the central shaft and movable axially along the central shaft. Each drum section comprises at least two portions which are connected together to fix the drum section around the central shaft. The at least two portions are disconnectable such that they are removable from the shaft in a radial direction of the shaft.

This threshing drum can be removed by moving the drum sections along the central shaft, and when a drum section has reached an accessible position (e.g. outside the main body of the combine on a shaft extension) it can be removed by splitting the section and removing the different portions radially. The threshing drum can in this way be removed from the side of the combine in sections, eliminating the need for two people working and also eliminating the need to remove a wheel.

Each drum section for example comprises two side-by-side discs. The two discs provide a spaced support structure, for example for supporting threshing elements such as rasp bars.

The at least two drum portions are for example fastened together to form the drum section. The drum portions may thus be disconnected by unfastening, so that they may then be removed from the central shaft radially (i.e. perpendicular to the shaft axis). This enables the threshing drum removal to require only a small amount of space.

Each drum section is for example connected to, and disconnectable from, the adjacent drum section or the adjacent drum sections. Thus, when connected, the drum sections form a unitary threshing drum.

Each drum section is for example connected to, and disconnectable from, the adjacent drum section or the adjacent drum sections by hubs that fit around the central shaft. Once the portions of the drum section have been removed, the hubs can also be removed that hold the drum sections together along the axis of the central shaft.

Each hub for example comprises at least two hub sections that are connected together to fix the hub around the central shaft, wherein the at least two hub portions are disconnectable such that they are removable from the shaft. They may also be removed radially.

Each drum section for example comprises threshing elements at the outer periphery of the drum section. The threshing elements of one drum section may be aligned with the threshing elements of the adjacent drum section or the adjacent drum sections. In this way, continuous lines of threshing elements are formed.

The central shaft is for example splined and the drum sections are keyed to the splined central shaft. The drum sections thus all rotate together as a single unit, driven by the central shaft.

The threshing drum may further comprise a shaft extension for extending the central shaft, to allow drum sections to be slid from the central shaft onto the shaft extension for disconnection. Thus, the drum sections are removed radially from the shaft extension.

This shaft extension is used as part of the removal process. It allows drum sections to be slid out of the body of the combine onto the shaft extension, and from there the portions can be radially removed.

At least one of the portions of each drum section may have a threaded bore. A threaded fastener may then be used to pull the drum section along the central shaft.

A removal system is for example provided, comprising a bracket and a threaded fastener mounted to the bracket, wherein the threaded fastener is for engaging with the threaded bore to pull the set of drum sections along the central shaft.

This disclosure also provides a combine harvester comprising a crop cutting head, the threshing drum as described above, a concave beneath the threshing drum and a grain separating and cleaning system for receiving the cut and threshed crop material. The threshing drum has an axis of rotation which extends in a transverse direction of the combine harvester.

The combine harvester for example has a frame, and comprises a lateral opening in the frame aligned with the threshing drum, along the direction of the axis of rotation of the threshing drum. A cover is for example provided for the lateral opening.

### BRIEF DESCRIPTION OF THE DRAWINGS

One or more embodiments of the invention/disclosure will now be described, by way of example only, with reference to the accompanying drawings, in which:

FIG. 1 shows a combine harvester which may be adapted in accordance with the invention;

FIG. 2 shows threshing system, separating apparatus and grain cleaning apparatus in more detail;

FIG. 3 shows a front portion of a combine harvester, with the crop header and front elevator housing removed so that the threshing drum can be seen;

FIG. 4 shows the threshing drum more clearly;

FIG. 5 shows a single drum section more clearly with the portions connected;

FIG. 6 shows a single drum section more clearly with the portions separated;

FIG. 7 shows a side view of the combine harvester with the cover removed from the opening to show an end view of the threshing drum;

FIG. 8 shows a perspective view of the front portion of the combine harvester, with the cover 106 in place;

FIG. 9 shows the combine harvester after the cover has been removed and with a shaft extension applied to the end of the central shaft;

FIG. 10 shows the drum sections having been pulled along the central shaft;

FIG. 11 shows the outermost drum section split into the two portions;

FIG. 12 shows an end view of the threshing drum with one portion laterally moved away from the central shaft;

FIG. 13 shows a side view of the threshing drum;

FIG. 14 shows an enlarged view of one drum section of the threshing drum of FIG. 13; and

FIG. 15 shows the central shaft.

### DETAILED DESCRIPTION

The invention will be described with reference to the Figures.

It should be understood that the detailed description and specific examples, while indicating exemplary embodiments of the apparatus, systems and methods, are intended for purposes of illustration only and are not intended to limit the scope of the invention. These and other features, aspects, and advantages of the apparatus, systems and methods of the present invention will become better understood from the following description, appended claims, and accompanying drawings. It should be understood that the Figures are merely schematic and are not drawn to scale. It should also be understood that the same reference numerals are used throughout the Figures to indicate the same or similar parts.

This disclosure relates to a threshing drum for a combine harvester that has a central shaft and a set of drum sections disposed side-by-side along the central shaft. The drum sections are movable axially along the central shaft, and this is used to slide the threshing drum out of the combine harvester. Each drum section comprises at least two portions which are connected together to fix the drum section around the central shaft. The at least two portions are disconnectable such that they are removable from the shaft in a radial direction of the shaft. Thus, the threshing drum can be removed from the combine harvester in axial sections, and those axial sections are split to separate them from the central shaft.

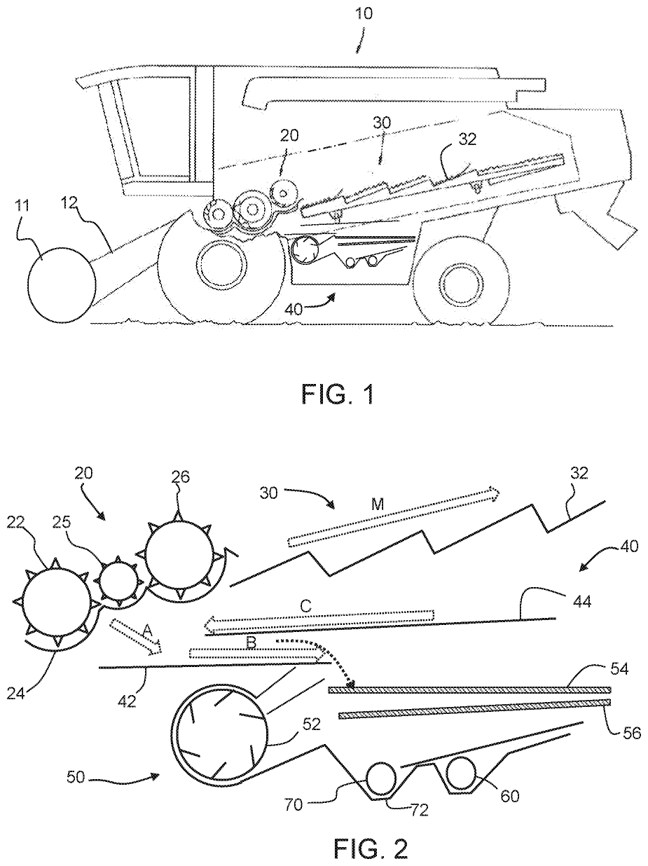

FIG. 1 shows a known combine harvester 10 to which the invention may be applied as a modification to the threshing system. A crop cutting head 11 (known as the header) for example comprises a wide laterally extending transverse auger, which cuts the crop material and drives it inwardly towards a central area. A front elevator housing 12 receives the cut crop material and includes a feederhouse for transporting the crop material.

The feederhouse delivers the crop material to a threshing system 20 for detaching grains of cereal from the ears of cereal, and a separating apparatus 30 which is connected downstream of the threshing system 20. The threshing system comprises one or more threshing units, in particular rotors, and associated concaves.

In the example shown, the separating apparatus 30 includes a plurality of parallel, longitudinally-aligned, straw walkers 32, and this is suitable for the case of a so-called straw-walker combine. The grains after separation by the separating device 30 pass to a grain cleaning apparatus 40.

The threshing system 20 is a tangential-flow ‘conventional’ threshing system, i.e. formed by rotating elements with an axis of rotation in the side-to-side direction of the combine harvester and for generating a tangential flow. For example, the ‘conventional’ threshing system includes a rotating, tangential-flow, threshing drum and a concave-shaped grate. The threshing drum includes rasp bars (not shown) which act upon the crop stream to thresh the grain or seeds from the remaining material, the majority of the threshed grain passing through the underlying grate and onto a stratification pan (also sometimes known as the grain pan).

In one known type of threshing system, as shown in FIG. 1, there is a beater drum after the threshing drum and a multi crop separator drum after the beater drum. Thus, it is well known to use three drums in the threshing system.

The threshing system 20, separating apparatus 30 and grain cleaning apparatus 40 are shown in more detail in FIG. 2.

The threshing system 20 includes a rotating, tangential-flow, threshing drum 22 and a concave-shaped grate 24. The threshing drum 22 includes rasp bars (not shown) which act upon the crop stream to thresh the grain or seeds from the remaining material, the majority of the threshed grain passing through the underlying grate 24 and onto a stratification pan 42 (also known as the grain pan).

The threshing system 20 also comprises a beater drum 25 (also with a transverse rotation axis and creating a tangential flow), downstream of the threshing drum and a tangential-flow multi-crop separator drum 26 (also with a transverse rotation axis and creating a tangential flow) downstream of the beater drum 25. They each have an associated grate beneath.

The remainder of the crop material including straw, tailings and un-threshed grain are passed from the threshing system 20 into the separating apparatus 30 as shown by arrow M.

In the example shown, the separating apparatus 30 includes a plurality of parallel, longitudinally-aligned, straw walkers 32, and this is suitable for the case of a so-called straw-walker combine. However, the separating apparatus 30 may instead include one or two longitudinally-aligned rotors which rotate about a longitudinal axis and convey the crop stream rearwardly in a ribbon passing along a spiral path. This is the case for a so-called hybrid combine.

In all cases, the separating apparatus 30 serves to separate further grain from the crop stream, and this separated grain passes through a grate-like structure onto an underlying return pan 44. The residue crop material, predominantly made up of straw, exits the machine at the rear. Although not shown in FIG. 1, a straw spreader and/or chopper may be provided to process the straw material as required.

The threshing apparatus 20 and separating apparatus 30 do not remove all material other than grain, “MOG”, from the grain so that the crop stream collected by the stratification pan 42 and return pan 44 typically includes a proportion of straw, chaff, tailings and other unwanted material such as weed seeds, bugs, and tree twigs. The stratification pan 42 and return pan 44 are driven in an oscillating manner to convey the grain and MOG accordingly.

The remainder of the grain cleaning apparatus 40 (i.e. a grain cleaning unit 50) is provided to remove this unwanted material thus leaving a clean sample of grain to be delivered to the tank.

The grain cleaning unit 50 comprises a fan unit 52 and sieves 54 and 56. The upper sieve 54 is known as the chaffer.

The grain passing through concave grate 24 falls onto the front of the stratification pan 42 as indicated by arrow A in FIG. 2. This material is conveyed rearwardly (in the direction of arrow B in FIG. 2) by the oscillating motion of the stratification pan 42 and the ridged construction thereof. Material passing through the grate of the separator apparatus 30 falls onto the return pan 44 and is conveyed forwardly by the oscillating motion and ridged construction thereof as shown by arrow C. It is noted that “forwardly” and “rearwardly” refer to direction relative to the normal forward direction of travel of the combine harvester.

When the material reaches a front edge of the return pan 44 it falls onto the stratification pan 42 and on top of the material conveyed from the threshing system 20 as indicated by arrow B.

The combined crop streams thus progress rearwardly towards a rear edge of the stratification pan 42. Whilst conveyed across the stratification pan 42, the crop stream, including grain and MOG, undergoes stratification wherein the heavier grain sinks to the bottom layers adjacent stratification pan 42 and the lighter and/or larger MOG rises to the top layers.

Upon reaching the rear edge of the stratification pan 42, the crop stream falls onto the chaffer 54 which is also driven in a fore-and-aft oscillating motion. The chaffer 54 is of a known construction and includes a series of transverse ribs or louvers which create open channels or gaps therebetween. The chaffer ribs are angled upwardly and rearwardly so as to encourage MOG rearwardly whilst allowing the heavier grain to pass through the chaffer onto an underlying second sieve 56. The chaffer 54 is coarser (with larger holes) than second sieve 56.

MOG which reaches the rear section either passes over the rear edge and out of the machine or through the associated grate before being conveyed to a returns auger 60 for re-threshing in a known manner. The majority of materials passing through the rear end of the chaffer 54 is un-threshed tailings.

Grain passing through chaffer 54 is incident on the lower sieve 56 which is also driven in an oscillating manner and serves to remove tailings from the stream of grain before being conveyed to on-board tank (not shown) by grain collecting auger 70 which resides in a transverse trough 72 at the bottom of the grain cleaning unit 50. Tailings blocked by sieve 56 are conveyed rearwardly by the oscillating motion thereof to a rear edge from where the tailings are directed to the returns auger 60 for reprocessing in a known manner.

This disclosure relates to the design of the threshing system and in particular the threshing drum 22.

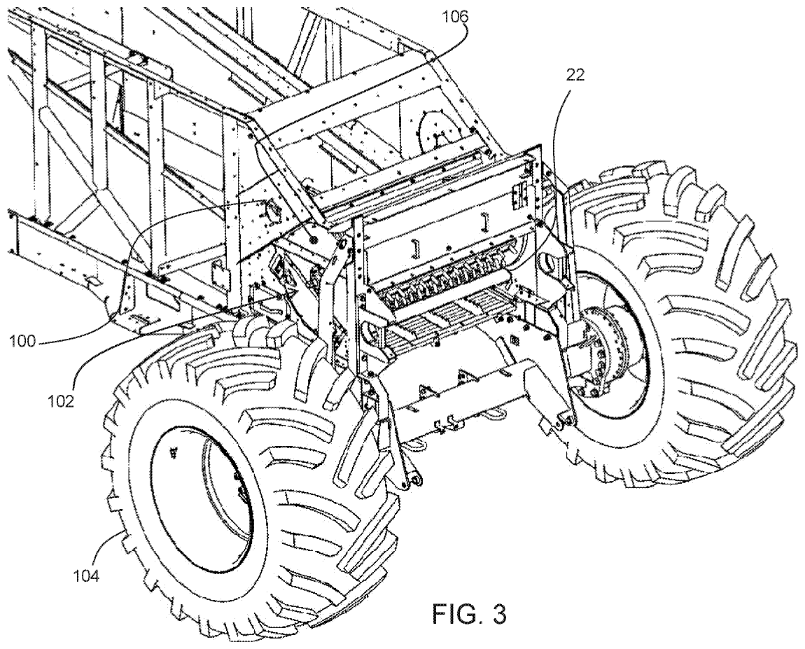

FIG. 3 shows a front portion of a combine harvester, with the crop header and front elevator housing removed so that the threshing drum 22 can be seen. The combine harvester has outer bodywork over a frame 100, and a lateral opening 102 is provided in the outer bodywork and the frame 100 laterally aligned with the threshing drum 22. As explained below, the threshing drum is designed to be removed through the lateral opening 102. The threshing drum is removable in small sections so that the front wheel 104 does not need to be removed. The lateral opening 102 is covered by a cover 106 (shown hinged open in FIG. 3) during normal use of the combine harvester.

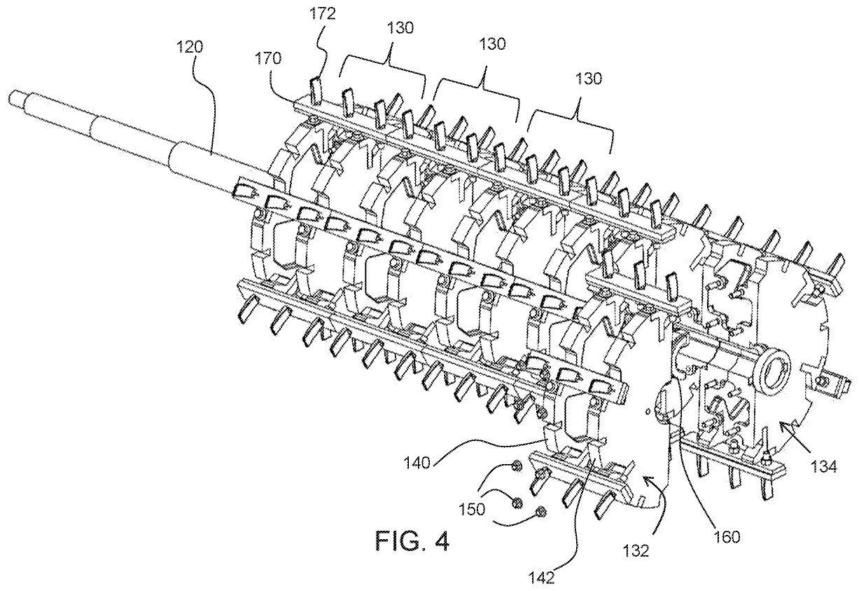

FIG. 4 shows the threshing drum more clearly. The threshing drum comprises a central shaft 120 and a set of drum sections 130 disposed side-by-side along the central shaft and movable axially along the central shaft.

As shown for one drum section, each drum section comprises two portions 132, 134 (in this particular example) which are connected together to fix the drum section 130 around the central shaft 120. The two portions 132, 134 are fastened together and they are disconnectable such that they are removable from the shaft in a radial direction of the shaft. The disconnected state of one drum section is shown in FIG. 4 and it can be seen that each drum section can be moved radially away from the central shaft 120.

This threshing drum can be removed by moving the drum sections 130 along the central shaft 120. When drum section has reached an accessible position (e.g. outside the main body of the combine) it can be removed from the shaft (or a shaft extension as explained below) by splitting the drum section 130 and removing the different portions 132, 134 radially. The threshing drum can in this way be removed from the side of the combine harvester in sections.

Each drum section 130 comprises two side-by-side discs 140, 142. The two discs provide a spaced support structure, for example for supporting threshing elements such as rasp bars.

The two drum portions are bolted together to form the drum section. Some of the nuts 150 for this purpose are shown. The drum portions may thus be disconnected by unbolting, so that they may then be removed from the central shaft radially.

Each drum section is connected to its adjacent drum sections by hubs 160. There is one hub at each junction between adjacent drum sections. The hubs are also split into hub portions that are fastened together so that they may be removed from the central shaft once the drum sections on each side have been removed.

The hubs function as clamps that couple the adjacent drum sections together as well as clamping them to the central shaft 120. The hubs mate with a shape feature of the drum sections so that they interlock with the drum sections to hold them together in the axial direction. Once the portions of the drum section have been removed, the hubs 160 can also be removed that hold the drum sections together along the central shaft 120.

Each drum section 130 has lines 170 of threshing elements 172 at the outer periphery of the drum section 130. The threshing elements 172 form a line parallel to the rotation axis and hence parallel to the central shaft 120. The threshing elements 172 of one drum section are aligned with the threshing elements 172 of the adjacent drum sections so that continuous lines of threshing elements are formed.

In the example shown, there are five drum sections 130 and each drum section 130 has six lines 170 of threshing elements 172 angularly spaced around the outer periphery. There may of course be any desired number of drum sections and any desired arrangement of threshing elements.

The central shaft 120 is splined and the drum sections have a central bore that is keyed to the splined central shaft. The drum sections thus all rotate together as a single unit.

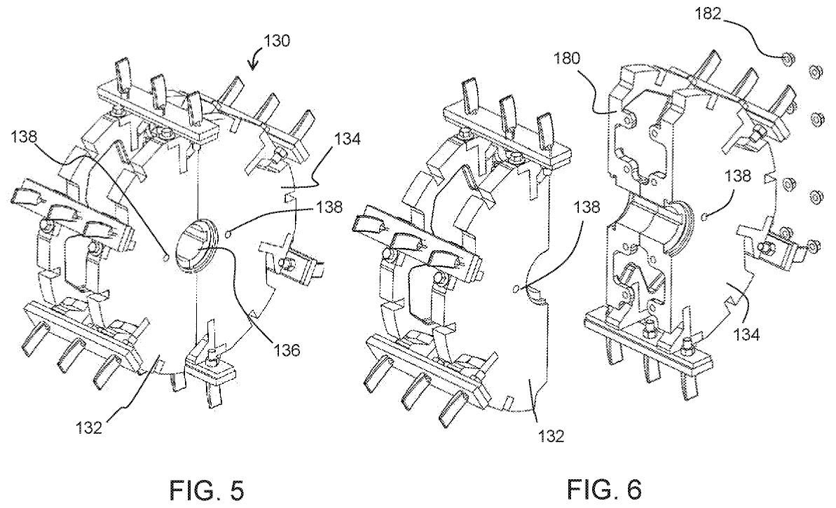

FIG. 5 shows a single drum section 130 more clearly with the portions 132, 134 connected. The keyed central opening 136 can be seen more clearly.

In addition, each portion 132, 134 has a threaded bore 138. As explained further below, one of the threaded bores is used to pull the drum sections along the central shaft. Only one portion needs to have a threaded bore. However, the portions may be identical (to reduce the component count) and hence they both have a threaded bore in the example shown.

FIG. 6 shows a single drum section 130 more clearly with the portions 132, 134 separated. The portions are connected at mating faces 180, one of which is shown. The mating faces are connected by nuts and bolts, and the nuts 182 are shown. Of course, other fasteners may be used.

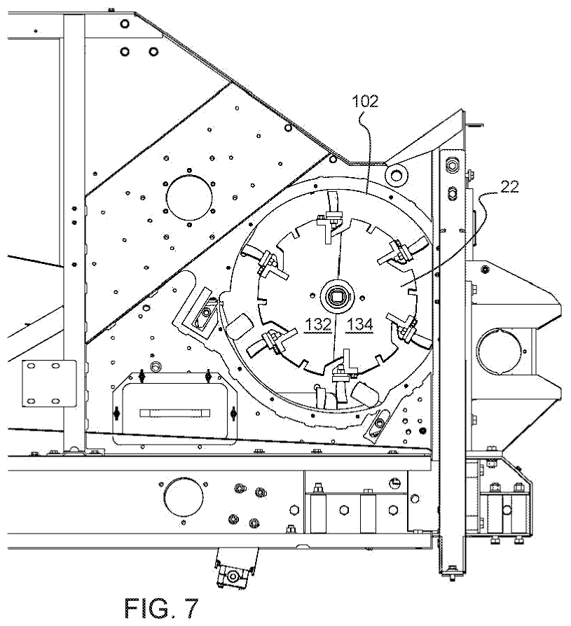

FIG. 7 shows a side view of the combine harvester with the cover removed from the opening 102 so that an end view of the threshing drum 22 is seen.

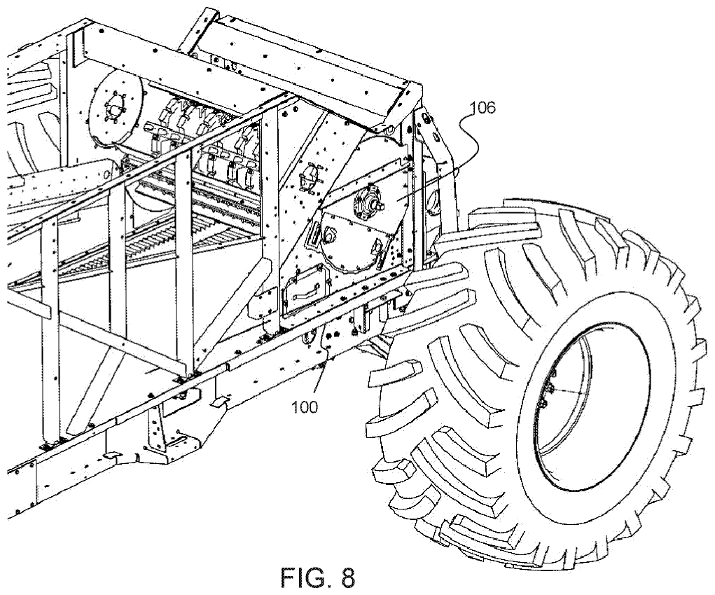

FIGS. 8 to 11 are used to show how the threshing drum is removed.

FIG. 8 shows a perspective view of the front portion of the combine harvester, with the cover 106 in place.

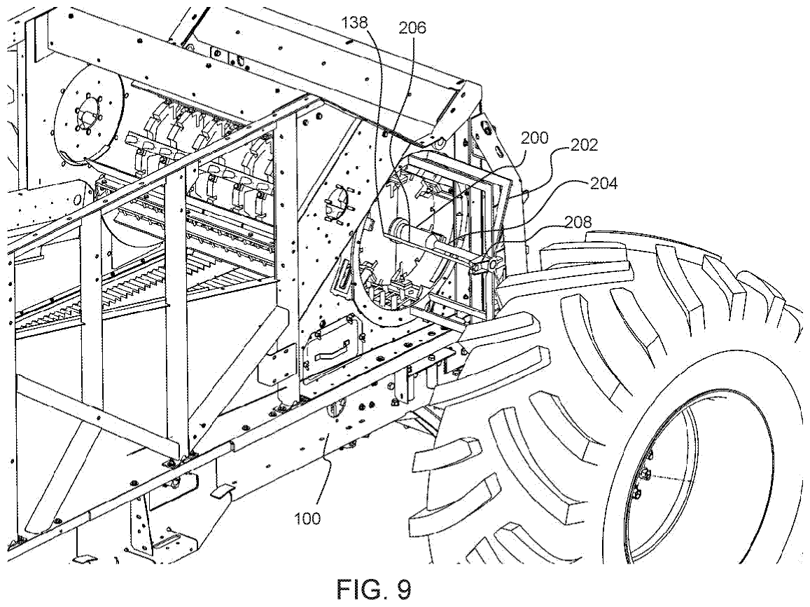

FIG. 9 shows the combine harvester after the cover has been removed. A shaft extension 200 is fitted to the end of the central shaft 120 for extending the central shaft. This shaft extension functions as a support to allow the drum sections 130 to be slid off the central shaft 120 and onto the shaft extension for disconnection.

The shaft extension 200 is held in place by a bracket 202 that couples to the frame 100 of the combine harvester. The bracket 202 functions as tooling to hold the threshing drum during its sliding out of the combine harvester body as explained below.

A central connector 204 of the bracket connects to the shaft extension 200. A threaded fastener 206 (bolt or screw) is held in place by a head 208 of the bracket 202. The threaded fastener 206 is screwed into the threaded bore 138 of one of the portions of the drum section. Once a head of the threaded fastener is retained by the head 208, the threaded fastener may be used to pull the threshing drum out of the combine harvester processor, sliding the drum sections along the central shaft. The head 208 provides the force to pull the threshing drum out of the combine harvester. Once the first drum section 130 is completely out of the body of the combine harvester, it is removed by unscrewing the threaded fastener 206, separating the drum section portions and removing them radially from the shaft extension 200. The threaded fastener is then screwed into one of the portions of the next drum section. This process is repeated until the last drum section 130 is removed.

The removal process does not require any removal or axial movement of the shaft 120. The threaded fastener 206 only needs a length sufficient to engage with the end threshing drum section, and the drum sections themselves have a short axial length. As a result, the maintenance of the threshing drum does not require removal of the front wheel.

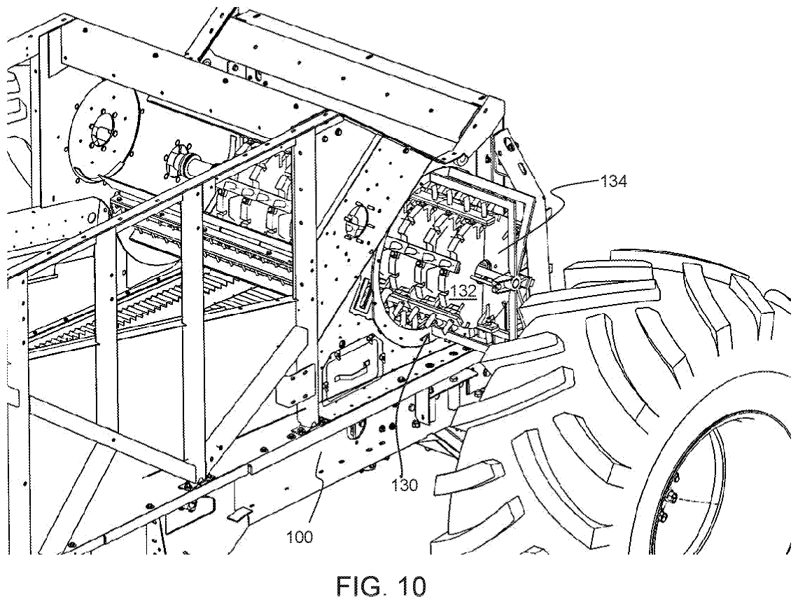

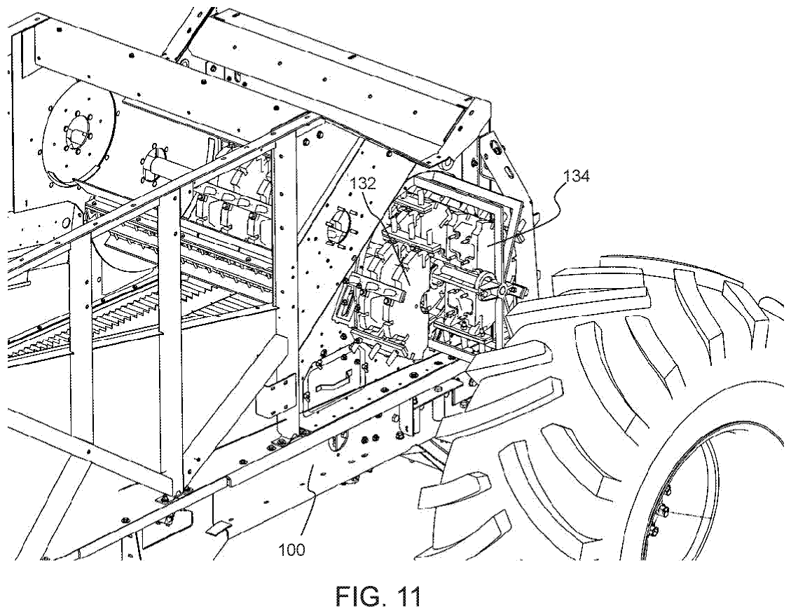

FIG. 10 shows the drum sections having been pulled along the central shaft 120 and onto the shaft extension so that one drum section is free of the body of the combine harvester.

FIG. 11 shows the outermost drum section split into its two portions 132, 134 by undoing the bolts that connect the drum sections. The hub 160 is also split into its portions by undoing its bolts, so that the drum portions and hub portions are removed.

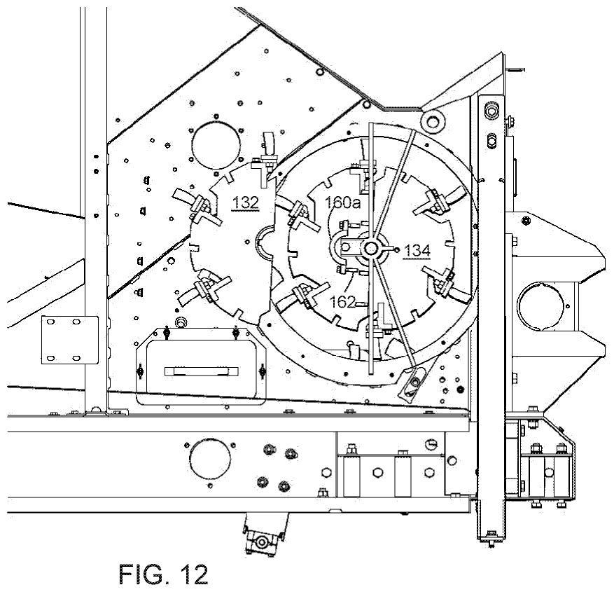

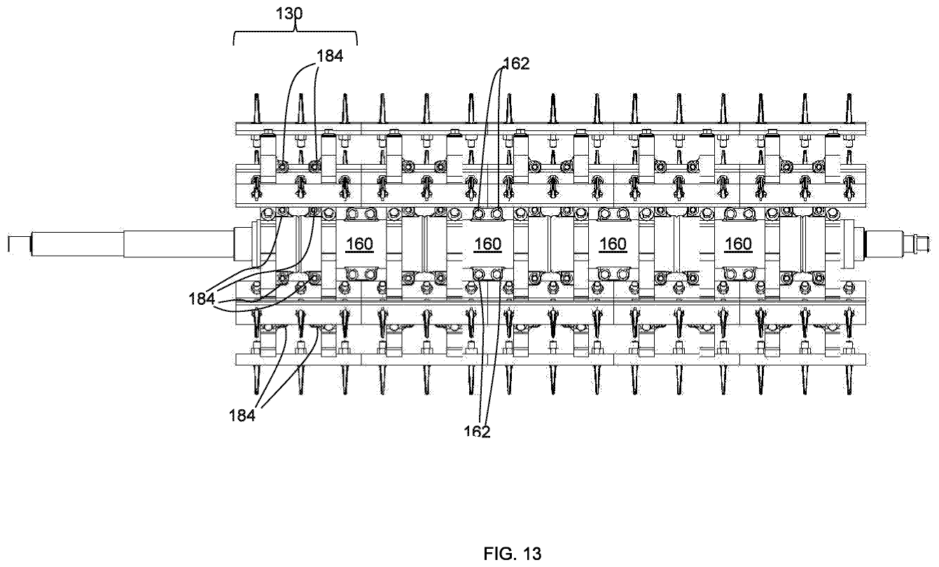

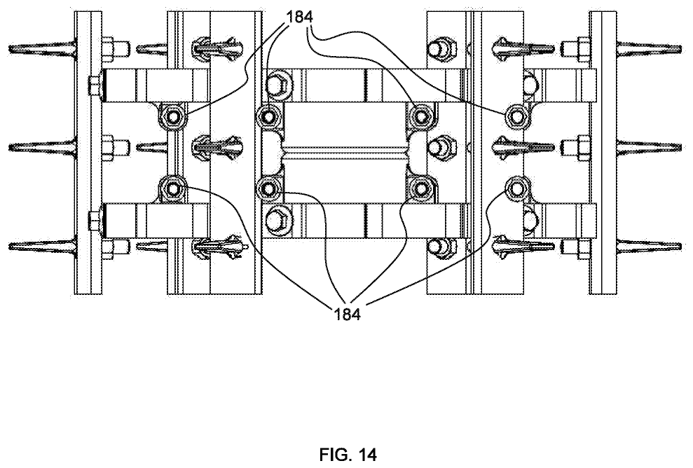

FIG. 12 shows an end view of the threshing drum with one portion 132 laterally moved away from the central shaft. It also shows the split hub more clearly. The hub has two hub portions, and one hub portion 160a is seen in FIG. 12. It is bolted to the other hub portion, and the connecting bolts 162 are removed to split the hub into its hub portions.

FIG. 13 shows a side view of the threshing drum. The bolts 162 that fasten the hub portions together are labelled for one hub 160. There are four bolts 162 for each hub in this example.

The bolts 184 that fasten the drum portions together to form a hub section are labelled for one drum section 130. There are eight bolts for each drum section in this example.

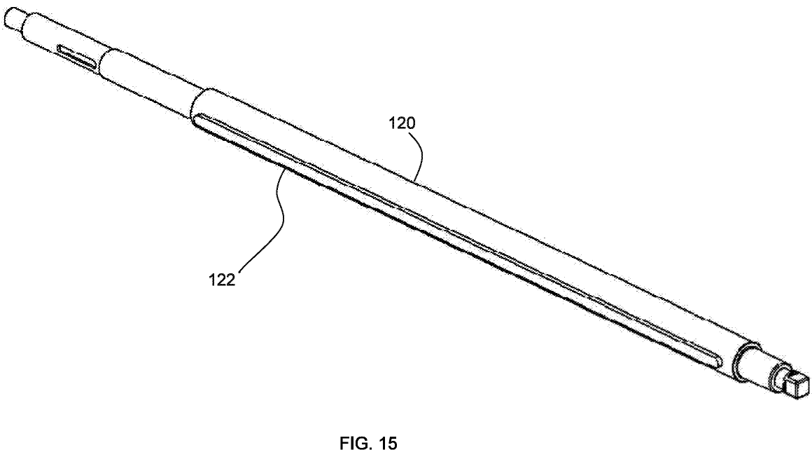

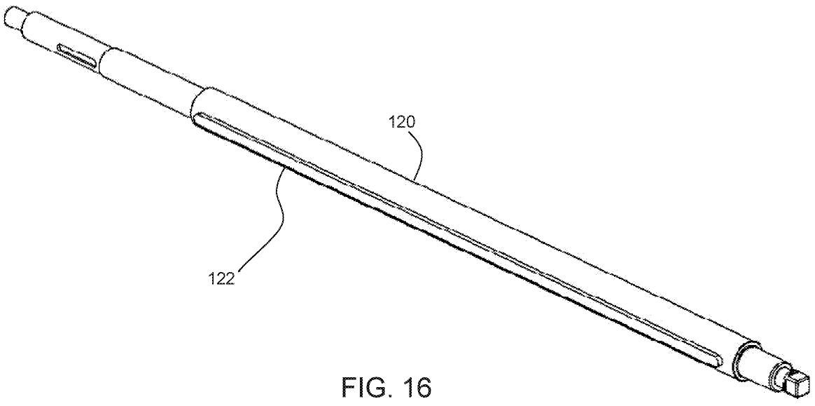

FIG. 15 shows an enlarged view of one drum section (without the hub).

FIG. 16 shows the central shaft 120 with a spline 122 for keying with the drum sections, to drive rotation of the drum sections.

Bolts have been shown in the figures for coupling parts together. Any suitable fastenings may be used, such as screws, bolts or other fastening elements.

Variations to the disclosed embodiments can be understood and effected by those skilled in the art in practicing the claimed invention, from a study of the drawings, the disclosure and the appended claims. In the claims, the word “comprising” does not exclude other elements or steps, and the indefinite article “a” or “an” does not exclude a plurality.

The mere fact that certain measures are recited in mutually different dependent claims does not indicate that a combination of these measures cannot be used to advantage.

Any reference signs in the claims should not be construed as limiting the scope.

All references cited herein are incorporated herein in their entireties. If there is a conflict between definitions herein and in an incorporated reference, the definition herein shall control.

What is claimed is:

1. A threshing drum for a combine harvester, comprising:
a central shaft;
a set of drum sections disposed side-by-side along the central shaft and movable axially along the central shaft,
wherein each drum section comprises at least two portions which are connected together to fix the drum section around the central shaft, wherein the at least two portions are disconnectable such that they are removable from the shaft in a radial direction of the shaft.

2. The threshing drum of claim 1, wherein each drum section comprises two side-by-side discs.

3. The threshing drum of claim 1, wherein the at least two drum portions are fastened together by screws or bolts to form the drum section.

4. The threshing drum of claim 1, wherein each drum section is connected to, and disconnectable from, the adjacent drum section or the adjacent drum sections.

5. The threshing drum of claim 4, wherein each drum section is connected to, and disconnectable from, the adjacent drum section or the adjacent drum sections by a hub or hubs that fit around the central shaft.

6. The threshing drum of claim 5, wherein each hub comprises at least two hub sections that are connected together to fix the hub around the central shaft, wherein the at least two hub portions (106a) are disconnectable such that they are removable from the shaft.

7. The threshing drum of claim 1, wherein each drum section comprises threshing elements at an outer periphery of the drum section.

8. The threshing drum of claim 7, wherein the threshing elements of one drum section are aligned with the threshing elements of the adjacent drum section or the adjacent drum sections.

9. The threshing drum of claim 1, wherein the central shaft is splined and the drum sections are keyed to the splined central shaft.

10. The threshing drum of claim 1, further comprising a shaft extension for extending the central shaft, to allow the drum sections to be slid from the central shaft to the shaft extension for disconnection.

11. The threshing drum of claim 1, wherein at least one of the portions of each drum section has a threaded bore.

12. The threshing drum of claim 11, further comprising a removal system comprising a bracket and a threaded fastener mounted to the bracket, wherein the threaded fastener is for engaging with the threaded bore to pull the set of drum sections along the central shaft.

13. A combine harvester comprising:
a crop cutting head;
the threshing drum of claim 1, the threshing drum having an axis of rotation which extends in a transverse direction of the combine harvester;
a concave beneath the threshing drum; and
a grain separating and cleaning system for receiving the cut and threshed crop material.

14. The combine harvester of claim 13, comprising a frame, and comprising a lateral opening in the frame aligned with the threshing drum, along the direction of the axis of rotation of the threshing drum.

15. The combine harvester of claim 14, further comprising a cover for the lateral opening.
